(19) United States
(12) Patent Application Publication
(10) Pub. No.: US 2026/0319486 A1
(43) Pub. Date: Oct. 15, 2026

(54) METHOD AND DEVICE FOR THE AUTOMATED PROCESSING OF ONE OR MORE ALERTS IN AN AIRCRAFT

(71) Applicant: SAFRAN ELECTRONICS & DEFENSE, PARIS (FR)

(72) Inventors: Georges RIC, MOISSY CRAMAYEL (FR); Alexandre ARTAULT, MOISSY CRAMAYEL (FR); Bruno PALACIOS, MOISSY CRAMAYEL (FR); Michael NAHMIYACE, MOISSY CRAMAYEL (FR)

(21) Appl. No.: 19/478,734

(22) PCT Filed: Apr. 22, 2024
(86) PCT No.: PCT/FR2024/050524

§ 371 Date: Oct. 24, 2025

(30) Foreign Application Priority Data
Apr. 27, 2023 (FR) FR2304289

(51) Int. Cl. G05B 23/02; B64D 45/00

(52) U.S. Cl. CPC G05B 23/0286; B64D 2045/0085

(57) ABSTRACT

A method for the automated processing of one or more alerts in an aircraft, an alert being associated with an event concerning the state of the aircraft, which event can be associated with one or more alerts, the method being implemented by an automated processing system including one or more digitised control panels and a computing unit, the method including preparing the processing of the alerts; evaluating one or more procedures associated with each alert; selecting an execution mode for the procedures to be implemented from a manual mode, in which the actions associated with each procedure are executed by the user themselves, and an automatic mode, in which the actions associated with each procedure are executed by the automated processing system; executing the procedures in the ordered list of the procedures to be implemented; and displaying the actions implemented.

### TECHNICAL FIELD OF THE INVENTION

The technical field of the invention is that of alert management in an aircraft.

The present invention relates to a method for processing alerts in an aircraft and, in particular, a method for partially or totally automating said processing.

### TECHNOLOGICAL BACKGROUND OF THE INVENTION

When an aircraft is faced with the set of major failures, the pilot(s) must carry out a set of procedures to decide whether the aircraft can remain in a stable flight condition and sufficiently airworthy to continue the flight/mission in progress, or whether it is necessary to divert to land as soon as possible.

During a major event such as an engine explosion damaging part of the aircraft wing, dozens of alerts related to major system failures are displayed to the pilots. This large number of alerts requires rapid processing and decision-making, which can be complex. When there are several pilots in the aircraft, they can process a large number of alerts, for example by dividing up the task of checking all the systems of the aircraft in order to identify which systems are available. However, this division of tasks and their cooperative processing in a crisis situation is not necessarily easy. Furthermore, when a pilot is alone, it is sometimes impossible for him/her to handle all the alerts because there are so many and they are so complex. There is therefore a need to assist the pilot(s) in managing alerts.

In order to assist the pilot(s) in managing alerts, document WO 2021130520 A1 provides a fault management system for complex systems. More particularly, the system provided determines and restores functionality of faulty systems and sub-systems using an intervention approach based on a directed graph of the state of the system. However, while such a system improves the information available to pilots, it does not allow for even partial automation of alert resolution.

There is therefore a need for a device and a method for at least partially automating management of alerts.

### SUMMARY OF THE INVENTION

The invention offers a solution to the problems discussed previously by providing a method for the automated processing of one or more alerts in an aircraft.

For this, a first aspect of the invention relates to a method for automatically processing one or more alerts in an aircraft, an alert being associated with an event relating to the state of the aircraft, an event being able to be associated with one or more alerts, the method being implemented by an automated processing system comprising one or more digitised control panels and a calculation unit, the method comprising:
A step of preparing processing of the alerts, including:
   A sub-step of storing the alerts as well as a severity level associated with each alert;
   A sub-step of checking absence of another automated alert processing already in progress;
A step of evaluating one or more procedures associated with each alert, said evaluation including:
   A sub-step of sorting and ordering the procedures as a function of a list of actions and checks to be performed associated with each procedure so as to obtain an ordered list of procedures to be implemented;
   A sub-step of displaying the ordered list of procedures to be implemented, with the procedures associated with the alert having the highest severity level and/or ensuring stable flight conditions being displayed first;
A step of selecting an execution mode of the procedures to be implemented from a manual mode in which the actions associated with each procedure are performed by the user himself/herself and an automatic mode in which the actions associated with each procedure are performed by the automated processing system;
A step of executing the procedures from the ordered list of procedures to be implemented, this execution being carried out in accordance with the ordering of said list when the automatic execution mode is selected by the user, said step including, for each action associated with each procedure:
   When the automatic execution mode is selected by the user, a sub-step of executing the action by the automated processing system;
   For each action executed during the preceding sub-step or executed by the user, a sub-step of updating progress of each procedure as well as the changes obtained associated with this progress in the state of the aircraft;
A step of displaying the actions implemented during the preceding step, the changes obtained and/or expected associated with each of these actions, and matching between the changes obtained and the changes expected.

By virtue of the invention, it is possible to partially or totally automate processing of these alerts, especially by sorting and ordering the alerts to be processed and the actions and checks to be carried out. It further guides the user (for example: the pilot) in processing these alerts when the same chooses to process all or part of these alerts manually. Especially, the invention reduces the burden on the user (for example the pilot) during the management of an abnormal situation, allowing him/her to focus on flying the aircraft.

Further to the characteristics just discussed in the preceding paragraph, the method according to one aspect of the invention may have one or more additional characteristics from among the following, considered individually or according to any technically possible combinations.

In one embodiment, the step of selecting a execution mode of the procedures to be implemented includes a sub-step of displaying a dialogue box allowing the user to select the execution mode.

In one embodiment, the step of executing the procedures comprises, for at least one action associated with a procedure:
A sub-step of actuating the (digital) elements of the control panel(s); and/or
A sub-step of actuating one or more electrical contactors linked to the at least one action associated with the procedure, so as to switch off a faulty component and/or switch on a backup component.

In one embodiment, during the sub-step of updating progress of each procedure, a ticked box is displayed when an action is performed and a result obtained associated with said action is in accordance with an expected result.

By “result obtained associated with an action”, it is meant the result produced by the changes obtained associated with said action. By “expected result associated with an action”, it is meant the result produced by the expected changes associated with said action.

In one embodiment, at the end of the sub-step of updating progress of the procedure considered, when the changes obtained associated with the action considered do not comply with the expected changes associated with said action, the method includes a sub-step of selecting by the user one step to take of the following two steps to take:
continuing the current procedure or the next procedure if the current procedure is completed, by implementing the preceding sub-steps for the next action; or
when the changes obtained associated with the action considered necessitate the implementation of a new procedure, executing this procedure according to the previous sub-steps, with the processing of the current procedure resuming at the end of the implementation of the new procedure;

The selected step to take is implemented by the automatic processing system.

In one embodiment, at the end of the step of displaying the actions implemented, the method includes a step of transitioning the automated processing system to a monitoring mode in which the processing system is configured to detect occurrence of one or more alerts.

A second aspect of the invention relates to an automated alert processing system comprising at least one digitised control panel, a calculation unit connected to the digital control panel, and means for verifying state of the unit elements that make up a digital control panel, said automated alert processing system being configured to implement a method according to the first aspect of the invention.

A third aspect of the invention relates to a computer program comprising instructions which, when the program is executed by a computer, cause the apparatus according to the second aspect of the invention to execute the steps of the method according to the first aspect of the invention.

A fourth aspect of the invention relates to a computer-readable medium having the computer program according to one third aspect of the invention recorded thereon.

The invention and its different applications will be better understood upon reading the following description and examining the accompanying figures.

### BRIEF DESCRIPTION OF THE FIGURES

The figures are set forth by way of indicating and in no way limiting purposes of the invention.

FIGS. 1A to 1E show a schematic representation of a method according to the invention.

FIG. 2 shows a schematic representation of a system according to the invention.

FIG. 3 shows an extract from a MEL document.

FIG. 4 shows a schematic representation of the function GEP.

### DETAILED DESCRIPTION

The figures are set forth by way of indicating and in no way limiting purposes of the invention. Unless otherwise specified, a same element appearing in different figures has a single reference.

Hereinafter, a procedure is defined as one or more actions and/or checks to be performed. Furthermore, an action may be associated with several procedures and may be performed once or several times in each procedure.

### Method for the Automated Processing of One or More Alerts in an Aircraft

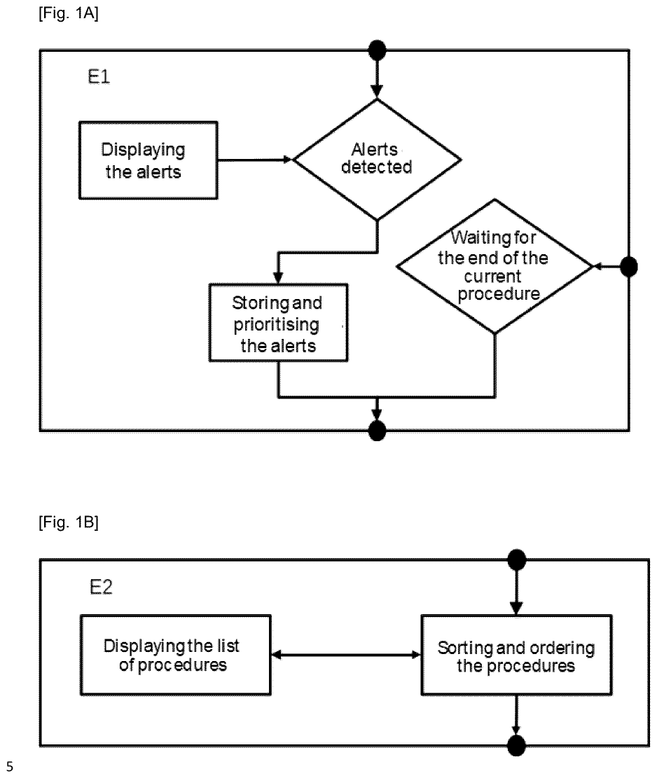

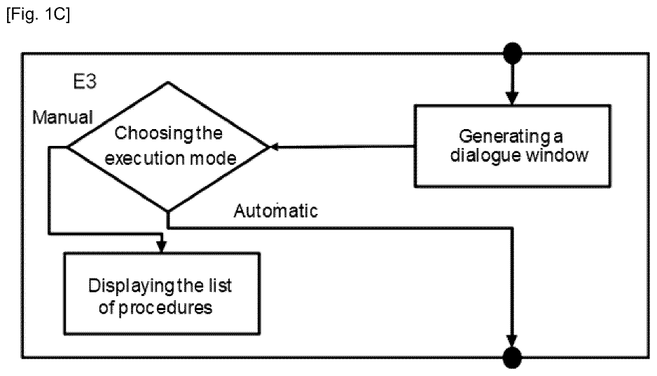

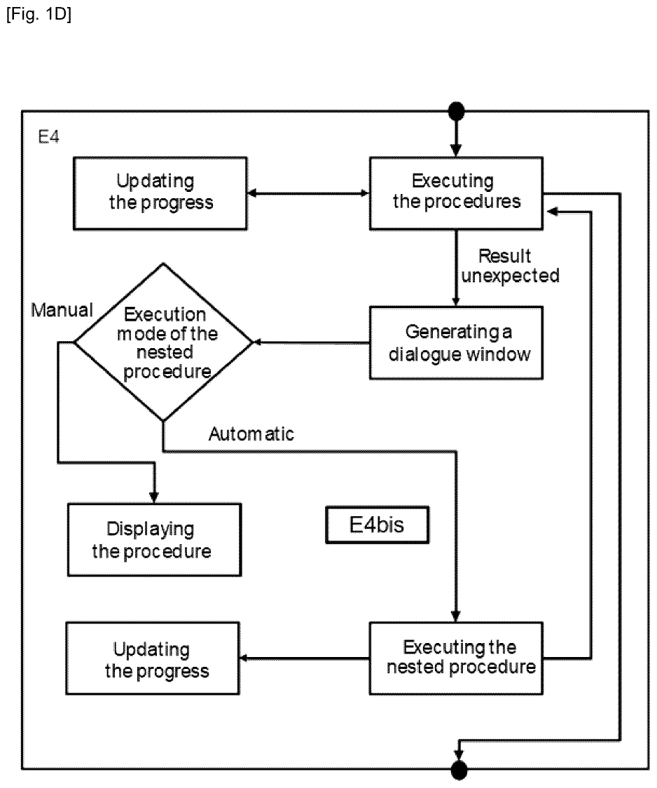

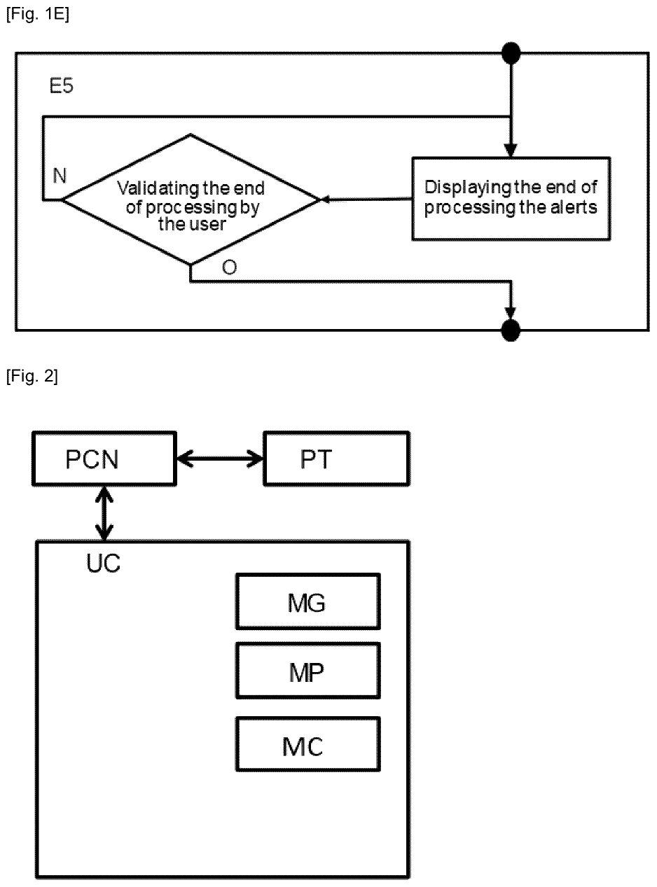

A first aspect of the invention illustrated in FIG. 1A to FIG. 1E relates to a method for automatically processing one or more alerts in an aircraft, an alert being associated with an event or situation relating to the state of the aircraft, an event or situation being able to be associated with one or more alerts.

More particularly, in an aircraft, the cockpit is generally equipped with systems that alert the user in the event of danger or system failures that impact the mission. These alerts are in a number of forms, for example:
Messages displayed on cockpit screens;
Visual indications by dedicated indicators (for example: orange or red as a function of the criticality of the situation), also referred to as “attention getters”;
Audible alerts via voice messages or sounds;
Sensory alerts via vibrations or pressure applied to the elements with which the user interacts with the aircraft.

These alerts can be of various kinds and are triggered in some situations (for example, in the event of a risk of collision with another aircraft, in the event of a risk of collision with an obstacle or with the terrain) or even as a function of some events (for example, in the event of a serious malfunction of one or more systems impacting the airworthiness of the aircraft).

The method according to the invention aims to partially or totally automate processing of these alerts, especially by sorting and ordering alerts to be processed and actions and checks to be carried out. The method further guides the user in processing these alerts when the user selects to process all or part of these alerts manually.

The method according to the invention is implemented by an automated processing system according to the invention (described in more detail in the second part of the description and illustrated in FIG. 2 to FIG. 4) comprising a calculation unit and one or more digitised control panels. The calculation unit comprises a calculation means such as a processor as well as a memory (for example: RAM type memory and/or a hard disk) configured to store data and instructions necessary for the implementation of the method according to the invention.

By virtue of digitisation, in a control panel of a modern aircraft, the behaviour of the unit elements and integrated panels can be verified either by user action or by a software function executed by the calculation unit of the system. These are generally referred to as digitised control panels. In the system according to the invention, when one or more alerts are triggered, the method according to the invention is implemented in order to execute the steps that will now be described.

### Step of Preparing Alert Processing

As illustrated in FIG. 1A, the method according to the invention first comprises a step E1 of preparing alert processing. This step E1 includes a sub-step of storing (for example in the memory of the system according to the invention) the alerts as well as a severity level associated with each alert.

This step also includes a sub-step of checking absence of another automated alert processing already in progress (for example related to a previous implementation of the method according to the invention). If no procedure is in progress, the method according to the invention continues. Otherwise, the method according to the invention is paused until the procedure(s) associated with the processing of a current alert are completed. Alternatively, several procedures associated with the processing of one or more alerts may be processed in parallel. The term “in parallel” herein means that their processing is concomitant and independent.

### Step of Evaluating One or More Procedures Associated with Each Alert

As illustrated in FIG. 1B, the method also includes a step E2 of evaluating one or more procedures associated with each alert, said evaluation including:
A sub-step of sorting and ordering the procedures, for example as a function of a list of actions and checks (or “Non-Normal Checklist”) to be performed associated with each procedure in order to obtain an ordered list of procedures to be implemented;
A sub-step of displaying the ordered list of procedures to be implemented, with the procedures associated with the alert having the highest severity level and/or ensuring stable flight conditions being displayed first.

In one exemplary embodiment, the sorting and ordering sub-step comprises, during the definition of the aircraft, the study of the set of fault trees of all components and systems of the aircraft. In addition, this study can be carried out more precisely for systems or components that have a significant impact on flight safety/airworthiness. This study enables the manufacturer to compile a document referred to as the Master Minimum Equipment List, or MMEL. This document estimates the impact of each component or system on flight airworthiness. The MMEL document, which may be provided by the aircraft manufacturer, is used to compile a more restrictive document, the MEL, which is the responsibility of the operator. In the case where there are several alerts to be processed, the sorting phase can determine which alerts can be made in parallel, one criterion being that the systems/components incriminated in the alerts have no functional links between them.

In one exemplary embodiment, the severity level of the procedures associated with the alert can be determined by taking two criteria into account: the level of impact of the failure of a component and/or system on holding the aircraft stability and/or, when there are several failures, which procedure to execute first to ensure aircraft stability as soon as possible. Thus, the procedures, which comprise a list of actions and checks to be made, are ordered according to their severity level.

In one exemplary embodiment, procedures are evaluated by taking two types of information into account: the first type is a list of actions associated with each alert and defined by the alert system, the second type is a list of actions and checks associated with each system and defined by the predictive function MEL, which identifies checks and potential operational restrictions to be taken into account during flight or during pre-flight maintenance. In one embodiment, the method includes a step of displaying to the user the restrictions to be taken into account when the flight phase in question is reached.

In one embodiment, the list of procedures and checks to be performed is displayed as a function of the order of priority, from the most important to the least important, with displaying also including MEL documentation elements presented to the user in correspondence with the highest priority alert to be processed.

### Step of Selecting Execution Mode

As illustrated in FIG. 1C, the method also includes a step E3 of selecting an execution mode for the procedures to be implemented from among a manual mode in which the actions associated with each procedure are performed by the user himself/herself and an automatic mode in which the actions associated with each procedure are performed by the automated processing system according to the invention. In other words, once the list of procedures to be implemented has been identified, the calculation unit of the system according to the invention is configured to request confirmation from the user before launching automatic execution of the procedures.

To do this, in one embodiment, the method comprises generating a message in a window (for example: a pop-up window) on the screen. The user can choose to validate automatic execution of the procedures (for example: by selecting “Y”) or not (for example: by selecting “N”). If the user selects “N”, he/she will have to manually execute the set of actions related to the procedure(s). However, by virtue of digitisation of all the elements with which the pilot interacts, the calculation unit is configured to record all state changes resulting from the user's actions. The calculation unit is also configured to broadcast these state changes to other functions, for example the predictive function MEL. This sharing of the current state of the cockpit and aeroplane systems allows onboard functions to correlate information to improve user assistance in pursuit of the mission.

### Step of Executing Procedures

As illustrated in FIG. 1D, the method also includes a step E4 of executing the procedures in the ordered list of procedures to be implemented, this execution being carried out in accordance with the ordering of said list when the automatic execution mode is selected by the user.

This step comprises, for each action associated with each procedure, when the automatic execution mode is selected by the user, a sub-step of executing the action by the automated processing system. When the execution mode is manual mode, each action is performed by the user and only the following sub-steps are implemented for each action performed by the user.

This step also comprises, for each action considered to have been executed during the preceding sub-step or executed by the user, a sub-step of updating progress of the procedure considered as well as the changes obtained associated with this progress in the state of the aircraft.

This step also comprises, when the changes obtained associated with the action considered are not in accordance with the expected changes associated with said action, a sub-step of selecting, by the user, one step to take from the following two steps to take:
Continuing the current procedure or the next procedure if the current procedure is complete, by the implementation of the preceding sub-steps for the next action, i.e. the next action in the current procedure or the first action in the next procedure if the current procedure is complete; or
When the changes obtained associated with the action considered necessitate the implementation of a new procedure, executing this procedure according to the preceding sub-steps, with the processing of the current procedure resuming at the end of the implementation of the new procedure;

The selected step to take is then implemented by the automated processing system. In one embodiment, the calculation unit is configured to evaluate impact and decide whether to:
Continue to execute the following actions in the procedure if the action or procedure that does not give the expected result does not impact the execution of the following actions or procedures;
Suspend execution of the following actions in the procedure and inform the user that the result obtained from an automatic action is different from the expected result. The decision to continue is that of the pilot/user. Processing this case is described in step E4bis.

Thus, the user only needs to intervene when the procedure impacts the execution of subsequent actions and procedures. As a general rule, the user evaluates the impact of the expected result of the suspended action. If the impact is low (or zero), the user may decide to restart the automatic execution of subsequent actions in the current procedure or subsequent procedures if the current procedure is complete.

If, on the other hand, the impact could be significant and/or could lead to one or more new procedures (also referred to as additional procedures or nested procedures) related to this new, unexpected state of a system, the user has the choice between making the actions of the nested procedure or procedures manually or automatically.

When the user decides to launch the automatic procedure, the calculation unit is configured to execute actions of the nested checklist procedure. Once the set of actions has been successfully completed, the calculation unit is configured to inform the user of the result obtained from the nested procedure. The user validates the result obtained from the nested procedure and, in the same time, validates continuation of the initial procedure. If, during the execution of the actions of the nested procedure, a new “unexpected” result is obtained, the process described previously is implemented again. The calculation unit is configured to implement the preceding steps (and sub-steps) as many times as necessary until the set of alerts has been processed.

In one embodiment, during the execution sub-step, the calculation unit is configured to execute actions associated with each procedure as follows:
By automatically driving the digital elements of control panels to modify behaviour of an aircraft function or system in accordance with the alert system procedure and/or the MEL predictive procedure,
By automatically driving modification of an electronic contactor via an Electrical Distribution Electronic Contactor Manager function to switch off a faulty system in accordance with the alert system procedure and/or the MEL predictive procedure, or to activate a compensation or backup system in accordance with the alert system procedure and/or the MEL predictive procedure.

In one embodiment, during the update sub-step, the calculation unit is configured to display progress of the execution of the actions listed by the procedure, using tick boxes validated, for example, each time an action is successfully made. This allows the user to track the progress of the actions. The information displayed relates, for example, to modifications in components of the digital control panels, system pages and/or procedures executed. In addition, the calculation unit is configured to record all state changes resulting from automated actions. Further, the calculation unit is configured to broadcast these state changes to other functions such as the predictive function MEL and the flight and system parameter acquisition function. This sharing of the current state of the cockpit and aeroplane systems allows the on-board functions to correlate information to improve user assistance in pursuit of the mission.

### Display Step

As illustrated in FIG. 1E, the method also includes a step E5 of displaying actions implemented in the preceding step, the changes obtained and/or expected associated with each of these actions, and matching between the changes obtained and the changes expected.

In one embodiment, once the set of procedures (and corresponding actions) have been executed, the calculation unit is configured to generate an information pop-up listing the set of procedures executed and the associated tick boxes showing the result obtained from the actions. In one embodiment, after the user has validated the result obtained, the calculation unit is configured to return to the state of continuous monitoring for the occurrence of aircraft system malfunction alerts.

### System According to the Invention

In order to implement the method according to the invention, a second aspect of the invention relates to an automated processing system comprising means configured to implement said method.

More particularly, the system according to the invention comprises a digitised control panel. In one exemplary embodiment illustrated in FIG. 2, the digitised control panel PCN according to the invention is configured to interact with touch panels PT. These control or touch panels can, by virtue of being digitised, be customised and/or modified, for example by reconfiguring the use of a button and/or panel, by improving the functional monitoring of a button and/or panel. The set of these panels is connected to the calculation unit UC (sometimes designated as RCCP/UCAP or RCCP for Remote Centralised Control Panel), and UCAP (Ultra-Compact Avionics Platform”), this calculation unit UC comprising the set of service modules, and especially:
An Arinc 661 graphics generation module (standard for the definition and making of certified aeronautical human-machine interfaces), which especially links to FIA, FIL and FIR functions;
An MP module for managing/driving the control panels, linking especially with the drive function FIP;
a centralised calculation module MC.

The calculation unit UC of the system according to the invention is configured to perform the main function associated with the method of the invention: the Screen Page Manager function, NNC (Non-Normal Checklist) execution and RCCP drive, hereinafter designated as the function GEP. This function GEP especially makes it possible to modify state of a digital element of the cockpit while recording the initial state and the modified condition in order to track any changes. It also makes it possible to automatically execute all or part of the routine checklist procedures during the flight preparation phase.

In the event of an abnormal situation or system failure, it also links to the contents of the Minimum Equipment List, accessible through a predictive function of a Minimum Equipment List commonly referred to as MEL, in order to automatically execute all or part of the procedures (and therefore actions and checks) associated with the management of the non-normal checklist (NNC). For the record, the information found in the MEL document is organised by system (chapter ATA for Air Transport Association, ATA 36 in the example above), sub-system (sub-chapter ATA 36-11), sub-sub-system or component (sub-sub-chapter ATA 36-11-05). This organisation makes it possible to identify in detail elements that contribute to the airworthiness of the aircraft.

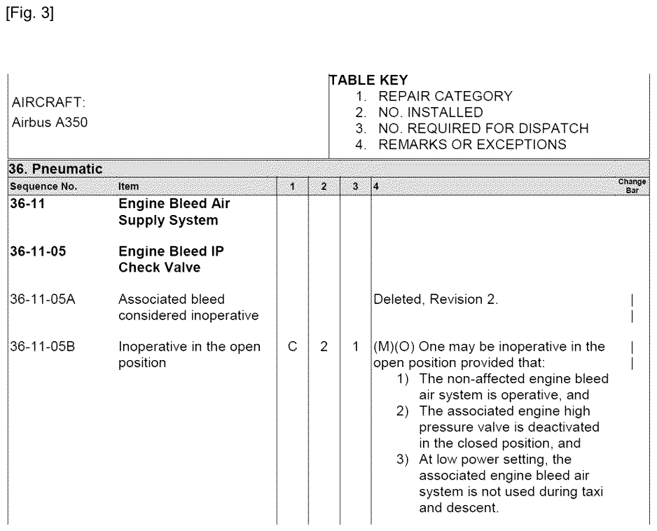

An example of an extract from an A350XWB MEL document published by the FAA, illustrating how the information is structured, is represented in FIG. 3. In this example, when the ‘Engine Bleed IP Check Valve’ condition detected as non-functional but in the ‘open’ position is met, there are two types of recommendations to be made:
(O): check operational impacts during flight to ensure continuity of operation
(M): if the fault occurs when the aircraft is on the ground, the decision to make the flight depends on verification of the functional impacts and the user taking them into account.

In this example, the device (or method) according to the invention, through the GEP software function, is configured to drive execution of the checks described in procedure (O) during flight, namely:
Check: Check that the engine bleed system not affected by the failure is fully operational; AND
Check: that the high-pressure valve of the engine affected by the bleed failure is deactivated and in the ‘closed’ position; AND
Restriction: At low power, do not use the bleed system of the affected engine during descent and taxiing.

In addition, the electronic power distribution switch manager makes it possible to verify drive of the operation of the electronic contactors. Indeed, some procedures may require a faulty system to be switched off in order to avoid any disruption to the overall behaviour of the aircraft. In other cases, a procedure may require a system power cycle (Off-On) to switch it to a specific operating mode. In other words, the link between the GEP software function and the electrical distribution electronic contactor manager function allows for the automation of electronic contactor drive.

Further, the function GEP generates system pages with a set of parameters and a high-level architecture plane. The system pages are displayed on the screen dedicated to system pages. The system pages provide a simplified view of a potentially complex system architecture, focusing on main elements. These pages are designed to serve as a means to inform the pilot concisely on the operating state of a system. The systems displayed are those that have an impact on the flight, regardless of the phase. For example, a flight cannot take off if one of the doors is not properly locked, this condition must be detected on the ground before the taxi phase. An example of a system page may include the following information (based on the A350XWB definition):
APU page—(ATA49)
BLEED page—(ATA36)
C/B page—status of open or tripped electronic contactors (ATA24)
CABIN PRESSURE page—cabin pressure and temperature (ATA21)
AIR CONDITIONING page—(ATA21) smoke detection indication and avionics bay and cargo bay
CRUISE page—Fuel, Air Conditioning and cabin pressure status.
DOOR page—(ATA52)
OXYGEN page (ATA35)
ELEC AC page—(ATA24)
ELEC DC page—(ATA24)
ENG page-supplementary page to dedicated engine displays (ATA70)
FLIGHT/CTRL page—(ATA27)
FUEL page—(ATA28 & 47)
HYDRAULIC page—(ATA29) & hydraulic circuit status with main parameters by valve exposure
WHEEL page—(ATA32) & status of landing gear, brakes and tyre pressure.

Thus, the GEP software function is configured to give the pilot the results of the checks via the system page(s) and indicates any operational restrictions to be taken into account, possibly reminding the pilot of these during the descent and taxi phases (in relation to the illustrative example used in this document).

The function GEP also links to a flight warning (FW) function that manages alerts communicated to the user on screen, on dedicated indicators or even audibly. More particularly, the flight warning function FW generates alerts in the event of system failure, but also when the aircraft is flying too close to the terrain, if there is a risk of collision, and more generally in any situation requiring the user's attention to take corrective action. Likewise, during normal operation or when no alerts are active (a situation not covered by the method according to the invention), the FWS system receives information circulating on the interconnection bus(es) of all aircraft systems under surveillance. The central function FC also receives information circulating on the interconnection bus(es) of all aircraft systems under surveillance and generates system pages from this information.

The function GEP also enables the automatic execution of step-by-step procedures while providing the necessary feedback to the user. In general, this feedback takes the form of system page displays on the display system, with a screen or screen zone dedicated to these displays (or “System Display”), changes in the state of the digitised cockpit control and/or any other means of keeping the user informed of the current situation or its course. For example, when a procedure may impact or interfere with a control action, this function can be configured to generate a message requesting the pilot/user's approval before executing the procedure.

The function GEP also links to all or part of the predictive function MEL to evaluate operational impacts of a system failure if the information is not already available in the NNC checklist.

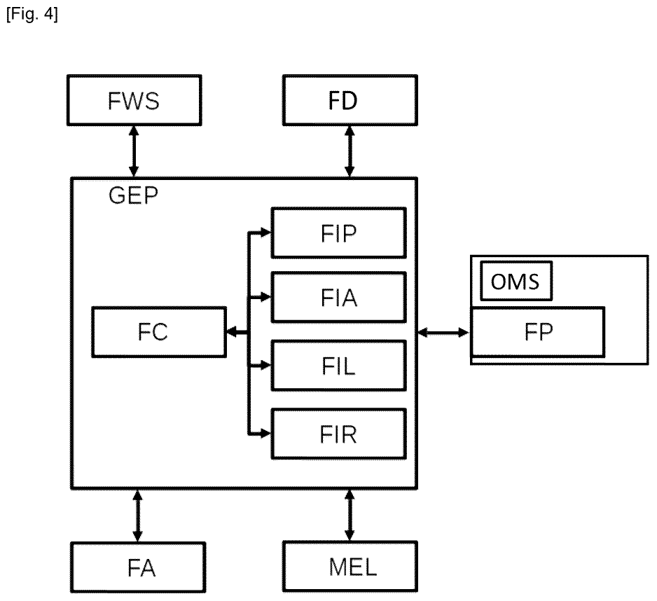

For this, as illustrated in FIG. 4, this function GEP is organised around a central automaton execution function, called the central FC function in the following. This central FC function links to the following external functions (i.e., those not part of the function GEP):
The function FWS or CAS (“Flight Warning System” or “Crew Alerting System”), which, between other things, displays alerts in the aircraft cockpit;
The management function FD for electrical contactors and electrical distribution;
The predictive function MEL;
The learning function FA;
The acquisition function FP for flight parameters and systems.

Further, within the function GEP, the central function FC links to the following internal functions:
The drive function FIP (RCCP);
The function for generating and displaying FIA system pages as well as procedures in the event of an alert;
The NNC (Non-Normal Check-List Procedures) function FIL;
The Routine Check-List (RC) Procedure function FIR.

In one embodiment, the different aircraft systems are connected to each other by one or more connection buses, and the central function FC is connected to the interconnection buses so that it can interact with the different aircraft systems, for example using the outer functions described previously. At the same time, the central function FC generates the system pages via the trusted graphics generation function (based on the Arinc 661 standard), acquires and records the state of the digital control panels via the function, acquires and records the state of the electronic contactors of the electrical distribution system, and provides all or part of this information to the predictive function MEL in order to feed a knowledge base from which the learning function will be learned and updated. The learning function will learn from all abnormal situations encountered and, above all, from how these abnormal situations have been managed and resolved. One of the objectives is to improve the sorting and ordering of procedures to be performed in front of a multi-alert situation and to determine whether the alerts should be managed sequentially or whether it is possible to parallelise processing of some of them. Hence, the idea is that this learning function will be deployed on all aircraft in a fleet and that all learning will be consolidated at the fleet level. The goal is to capitalise on the increased knowledge gained at the aircraft fleet level.

By virtue of this organisation, the calculation unit UC (sometimes referred to as the avionics platform) can continuously monitor for the appearance of malfunction alerts. This monitoring is possible thanks to the functional link between the GEP software function and the function FWS. Further, the predictive function MEL, which is based on the MEL structure, provides functionalities that enable optimal efficiency. Thus, the combination of the MEL function with the GEP software function on the one hand and the function OMS (On-board Maintenance System) on the other hand will make it possible to create an embedded collaborative space and a collection of the results obtained from all actions performed by the user and/or the function GEP to process alerts.

The function OMS is a centralised on-board maintenance function or system. Generally, the function OMS covers several functions such as the acquisition of flight parameters for processing by a prognostic function, and the acquisition of maintenance messages for processing by a diagnostic function. Thus, the flight and system parameter acquisition function receives information circulating on the interconnect bus(es) of all aircraft systems and from all systems capable of generating information in digital format and available on the interconnect bus(es).

Further, by virtue of the already mentioned digitisation of the cockpit, the GEP software function allows a learning function to be associated with the central function FC (so-called automated procedure drive and execution function). The purpose of this learning function is to continuously improve the level of user support. By virtue of this overall continuous improvement in alert management in a cockpit, the invention makes it possible to prepare transition between the different levels of autonomy as defined by EASA, namely: level 1=human assistance; level 2=human-machine collaboration; level 3=the machine executes, the human is in the loop.

In one embodiment, the central function FC of the function GEP is developed in accordance with the most stringent aeronautical standards in order to ensure the highest possible level of confidence in the execution of procedures. More particularly, the development of this function is based on the application of standards in accordance with a Design Assurance Level (DAL) objective; preferably, in the present case, the target DAL level will be B, i.e. a design that ensures that erratic behaviour with a hazardous consequence cannot have a probability of occurrence greater than 10^{e-7}, or A, i.e. a design that ensures that erratic behaviour with a ‘catastrophic’consequence cannot have a probability of occurrence greater than 10^{e-9}.

Thus, the system according to the invention just described, by implementing the method according to the invention, relieves the user of the burden of performing “low-level” procedures and tasks, allowing the same to focus on the stability and airworthiness of the aircraft while feeding a knowledge base on the airworthiness state of the aircraft.

1. A method for automatically processing one or more alerts in an aircraft, an alert being associated with an event relating to the state of the aircraft, an event being able to be associated with one or more alerts, the method being implemented by an automated processing system comprising one or more digitised control panels and a calculation unit, the method comprising:
a step of preparing processing of the alerts, including:
A sub-step of storing the alerts as well as a severity level associated with each alert;
A sub-step of checking absence of another automated alert processing already in progress;
a step of evaluating one or more procedures associated with each alert, said evaluation including:
a sub-step of sorting and ordering the procedures as a function of a list of actions and checks to be performed associated with each procedure in order to obtain an ordered list of procedures to be implemented;
a sub-step of displaying the ordered list of procedures to be implemented, with the procedures associated with the alert having the highest severity level and/or ensuring stable flight conditions being displayed first;
a step of selecting an execution mode of the procedures to be implemented from among a manual mode in which the actions associated with each procedure are executed by the user himself/herself and an automatic mode in which the actions associated with each procedure are executed by the automated processing system;
a step of executing the procedures from the ordered list of the procedures to be implemented, this execution being carried out in accordance with the ordering of said list when the automatic execution mode is selected by the user, said step including, for each action associated with each procedure:
when the automatic execution mode is selected by the user, a sub-step of executing the action by the automated processing system;
for each action executed during the preceding sub-step or executed by the user, a sub-step of updating progress of each procedure as well as the changes obtained associated with this progress in the state of the aircraft;
a step of displaying the actions implemented in the preceding step of executing, the changes obtained and/or expected associated with each of these actions, and matching between the changes obtained and the changes expected.

2. The method according to claim 1, wherein the step of selecting an execution mode of the procedures to be implemented includes a sub-step of displaying a dialogue window allowing the user to select the execution mode.

3. The method according to claim 1, wherein the step of executing the procedures comprises, for at least one action associated with a procedure:
a sub-step of actuating the (digital) elements of the control panel(s); and/or
a sub-step of actuating one or more electrical contactors linked to the at least one action associated with the procedure, so as to switch off a faulty component and/or switch on a backup component.

4. The method according to claim 1, wherein, during the sub-step of updating progress of each procedure, a ticked box is displayed when an action is made and a result obtained associated with said action is in accordance with an expected result.

5. The method according to claim 1, comprising, at the end of the sub-step of updating progress of the procedure considered, when the changes obtained associated with the action considered are not in accordance with the expected changes associated with said action, a sub-step of selecting by the user one step to take among the following two steps to take:
continuing the current procedure or the next procedure if the current procedure is completed, by implementing the preceding sub-steps for the next action; or
when the changes obtained associated with the action considered necessitate the implementation of a new procedure, executing this procedure according to the previous sub-steps, with the processing of the current procedure resuming at the end of the implementation of the new procedure;
the selected step to take is implemented by the automatic processing system.

6. The method according to claim 1, comprising, at the end of the step of displaying the actions implemented, a step of transitioning the automated processing system to a monitoring mode in which the processing system is configured to detect occurrence of one or more alerts.

7. An automated alert processing system comprising at least one digitised control panel, a calculation unit connected to the digital control panel, and means for verifying state of the unit elements that make up a digital control panel, said automated alert processing system being configured to implement a method according to claim 6.

8. (canceled)

9. A non-transitory computer-readable medium, comprising instructions which, when the instructions are executed by a computer, cause the computer to perform the steps of the method according to claim 1.
